(19) United States
(12) Patent Application Publication
(10) Pub. No.: US 2006/0146572 A1
(43) Pub. Date: Jul. 6, 2006

(54) Light guide plate with V-shaped grooves

(75) Inventors: Chiu-Lien Yang, Miao-Li (TW); Brian (Xi-Yu) Guo, Miao-Li (TW); Yu Cheng Lin, Miao-Li (TW); Ching-Hung Teng, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,981

(22) Filed: Dec. 23, 2005

(30) Foreign Application Priority Data
Dec. 31, 2004 (TW) 93221391

(51) Int. Cl. F21V 7/04

(52) U.S. Cl. 362/615

(57) ABSTRACT

A light guide plate (2) includes a light output surface (20) and a bottom surface (22) opposite to the light output surface. The bottom surface defines a plurality of V-shaped grooves (221) thereat, and each of the V-shaped grooves is bounded by a pair of walls along a length thereof. The walls cooperatively form an apex angle, and each of the V-shaped grooves has an apex angle in a range of 67° to 85°. With such configuration, light beams input to the light guide plate can be directed and transmitted within the light guide plate toward particular desired directions. Such directions are typically directions toward a viewer of an associated liquid crystal display panel. Accordingly, a backlight module that employs the light guide plate may advantageously obtain more efficient utilization of illumination and greater brightness in particular desired directions.

### FIELD OF THE INVENTION

The present invention relates to light guide plates for use in a liquid crystal display (LCD) or the like, and more particularly to a light guide plate having V-shaped grooves in a bottom surface thereof.

### BACKGROUND

A typical LCD device includes a liquid crystal display panel, and a backlight system mounted under the liquid crystal display panel. The backlight system mainly comprises a light source and a light guide plate. The light guide plate is generally made of a transparent acrylic plastic, and is used for guiding the light beams emitted by the light source in order to uniformly illuminate the liquid crystal display panel.

In order to diffuse the light beams and emit them uniformly from a top surface of the light guide plate, protrusions or recesses are provided at a bottom surface of the light guide plate. Alternatively, a pattern of light diffusion dots is formed on the bottom surface of the light guide plate.

Referring to FIG. 8, an exemplary conventional backlight module 10 includes a light guide plate 11, two light sources 12, a frame 13, and reflective sheets 14. The frame 13 contains the light guide plate 11 and the light sources 12, and the light sources 12 are respectively disposed adjacent to opposite sides of the light guide plate 11. The light guide plate 11 includes a light output surface 110, and an opposite bottom surface 111 covered by the frame 13. A plurality of V-shaped grooves 112 is formed in the light guide plate 11 at the bottom surface 111. The reflective sheets 14 are disposed on a peripheral region of the light output surface 110.

In operation, light beams emitted from the light sources 12 propagate within the light guide plate 11 toward the V-shaped grooves 112 in directions approximately perpendicular thereto. The light beams are reflected and refracted at the V-shaped grooves 112, and are subsequently output from the light output surface 110 of the light guide plate 10. The reflective sheets 14 are used to reflect light beams at the peripheral region of the light guide plate 11 so that the light beams may continue to propagate until they can exit the light output surface 110. With this configuration, the light beams output from the light output surface 110 provide bright illumination.

However, there is ongoing demand for light guide plates to provide even greater brightness and more efficient utilization of illumination sources, including by way of directing the transmission of light beams. A new light guide plate for a backlight module which can meet this demand is desired.

### SUMMARY

In an exemplary embodiment, a light guide plate includes a light output surface and a bottom surface opposite to the light output surface. The bottom surface includes a plurality of V-shaped grooves thereat, and each of the V-shaped grooves defines an apex angle in a range of 67° to 85°.

In another embodiment, a light guide plate includes a light output surface and a bottom surface opposite to the light output surface. The bottom surface includes a plurality of V-shaped grooves thereat. Each of the V-shaped grooves is bounded by a pair of walls along a length thereof, and the walls cooperatively form an apex angle. One of the walls maintains an angle in a range of 47°˜58° relative to the bottom surface, and the other wall maintains an angle in a range of 50°˜90° relative to the bottom surface.

With either of these exemplary configurations, the light guide plate is able to direct the transmission of input light beams appropriately. Accordingly, a backlight module that employs the light guide plate may obtain a more efficient utilization of illumination and greater brightness in particular desired directions. Such directions are typically directions generally toward a viewer of an associated liquid crystal display panel.

Other advantages and novel features will become more apparent from the following detailed description when taken in conjunction with the accompanying drawings.

### BRIEF DESCRIPTION OF THE DRAWINGS

FIG. 1 is a schematic, cross-sectional view of a light guide plate according to a first embodiment of the present invention, the light guide plate defining a plurality of non-uniform V-shaped grooves.

FIG. 2 is an enlarged view of a circled portion II of FIG. 1.

FIG. 3 is a schematic, cross-sectional view of a light guide plate according to a second embodiment of the present invention, the light guide plate defining a plurality of uniform V-shaped grooves.

FIG. 4 is a graph showing a relation between a reciprocal of luminous flux and a constant apex angle of V-shaped grooves of various different light guide plates, all of such light guide plates being configured according to the second embodiment of the present invention.

FIG. 5 is a schematic, inverted, isometric view of a light guide plate according to a third embodiment of the present invention.

FIG. 6 is a schematic, simplified, inverted isometric view of a light guide plate according to a fourth embodiment of the present invention.

FIG. 7 is a schematic, inverted, isometric view of a light guide plate according to a fifth embodiment of the present invention.

FIG. 8 is a schematic, cross-sectional view of a conventional backlight module.

### DETAILED DESCRIPTION OF PREFERRED EMBODIMENTS

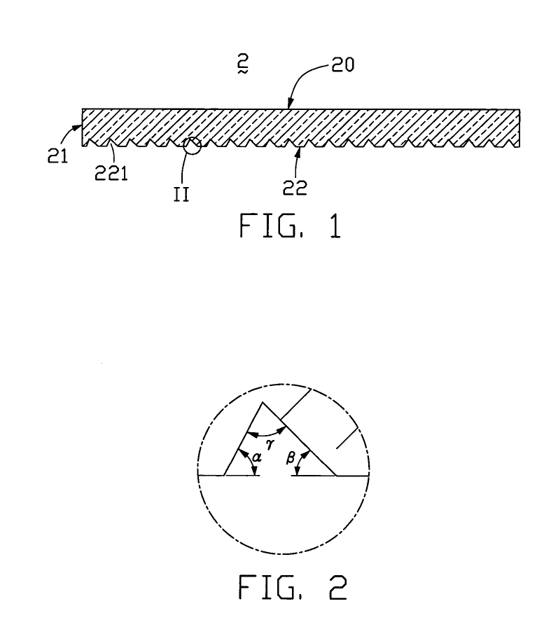

Referring to FIG. 1, a light guide plate 2 according to a first embodiment of the present invention includes a light input surface 21, a light output surface 20 adjacent to the light input surface 21, and a bottom surface 22 opposite to the light output surface 20. The bottom surface 22 defines a plurality of rectilinear, V-shaped grooves 221 thereat. Each of the V-shaped grooves 221 spans from one lateral side of the light guide plate 2 to an opposite lateral side of the light guide plate 2. The V-shaped grooves 221 are parallel to the light input surface 21, and are spaced apart from each other a uniform distance 22. All the V-shaped grooves 221 have a same height. In an alternative embodiment, the V-shaped grooves 221 may be adjacent each other, with no spaces between adjacent V-shaped grooves 221.

Also referring to FIG. 2, this shows an enlarged view of a profile of one of the V-shaped grooves 221. Each of the V-shaped grooves 221 is bounded by a pair of walls (not labeled), and each of the walls is continuous along a length thereof. The walls of each of the V-shaped grooves 221 cooperatively form an apex angle γ. One of the walls maintains an angle α relative to the bottom surface 22, and the other wall maintains an angle β relative to the bottom surface 22. The angles γ, α, and β of each of the V-shaped grooves 221 may be formed to enable all the V-shaped grooves 221 to have varying shapes. With such configuration, light beams input to the light input surface 21 can be directed and transmitted within the light guide plate 2 toward particular desired directions. Such directions are typically directions toward a viewer of an associated liquid crystal display panel. Accordingly, a backlight module that employs the light guide plate 2 may advantageously obtain more efficient utilization of illumination and greater brightness in particular desired directions.

The angles γ, α, and β defined by the V-shaped grooves 221 may be configured according to the brightness and other characteristics of the light source used. For example, the angle α is set in a range of 47°˜58°, and accordingly, the angle β is set in a range of 50°˜90°.

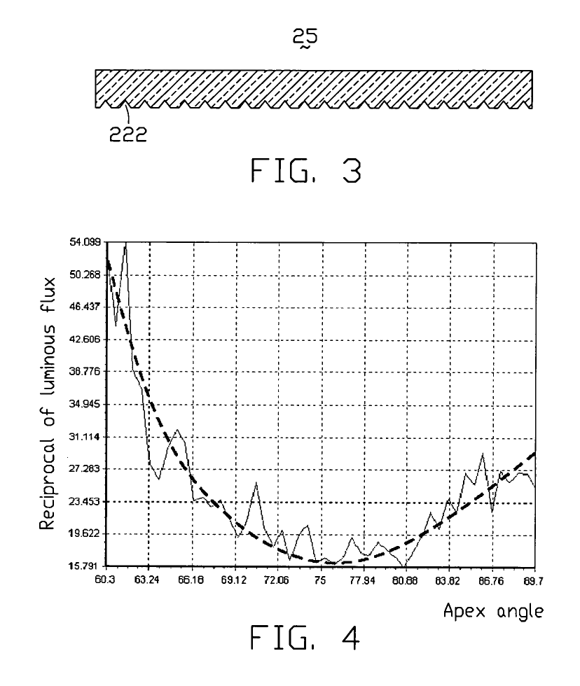

Referring to FIG. 3, a light guide plate 25 according to a second embodiment of the present invention is shown. The light guide plate 25 has a structure similar to that of the light guide plate 2 of the first embodiment. However, all of V-shaped grooves 222 have the same shape, and each of the V-shaped grooves 222 defines an apex angle of 75°. Therefore, the light guide plate 25 may obtain a more efficient utilization of illumination and greater brightness.

FIG. 4 shows a relation between a reciprocal of luminous flux and a constant apex angle of V-shaped grooves of various different light guide plates, all of such light guide plates being configured according to the light guide plate 25 of the second embodiment. For each of the various different light guide plates, the angle α is equal to the angle β, and the luminous flux is measured in respect of light propagating in an upward direction. Each abscissa represents the constant apex angle of the V-shaped grooves of the particular light guide plate measured, and the ordinate represents the reciprocal of luminous flux for that light guide plate. It is apparent that luminous flux is greatest when the constant apex angle γ of the V-shaped grooves is in the range from 67°˜85°, with approximately 75° being optimum.

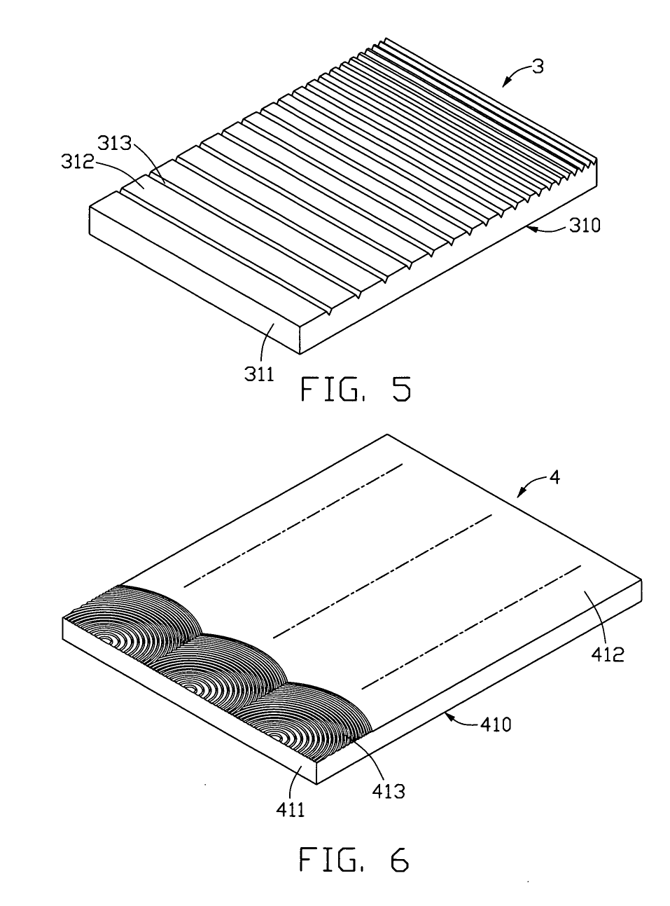

Referring to FIG. 5, a light guide plate 3 according to a third embodiment of the present invention has a structure similar to that of the light guide plate 2. The light guide plate 3 includes a light input surface 311, a light output surface 310 adjacent to the light input surface 311, and a bottom surface 312 opposite to the light output surface 310. The bottom surface 312 defines a plurality of rectilinear, V-shaped grooves 313 thereat. Each of the V-shaped grooves 313 spans from one lateral side of the light guide plate 3 to an opposite lateral side of the light guide plate 3. A density of distribution of the V-shaped grooves 313 increases along a direction away from the light input surface 311 of the light guide plate 3. Each of the V-shaped grooves 313 defines an apex angle (not labeled) of about 750. With such configuration, light beams input to the light input surface 311 can be directed and transmitted within the light guide plate 3 toward particular desired directions. Such directions are typically directions toward a viewer of an associated liquid crystal display panel. Accordingly, a backlight module that employs the light guide plate 3 may advantageously obtain more efficient utilization of illumination and greater brightness in particular desired directions.

Referring to FIG. 6, a light guide plate 4 according to a fourth embodiment of the present invention has a structure similar to that of the light guide plate 2. The light guide plate 4 includes a light input surface 411, a light output surface 410 adjacent to the light input surface 411, and a bottom surface 412 opposite to the light output surface 410. The bottom surface 412 defines a plurality of V-shaped grooves 413 thereat. The V-shaped grooves 413 are formed as three sets. Each set of V-shaped grooves 413 includes semicircular grooves and arc-shaped grooves, all of which are essentially concentric relative to a single reference point. A point light source (not shown) is disposed at each reference point. Each of the V-shaped grooves 413 defines an apex angle (not labeled) of about 75°. With such configuration, light beams input to the light input surface 411 can be directed and transmitted within the light guide plate 4 toward particular desired directions. Such directions are typically directions toward a viewer of an associated liquid crystal display panel. Accordingly, a backlight module that employs the light guide plate 4 may advantageously obtain more efficient utilization of illumination and greater brightness in particular desired directions.

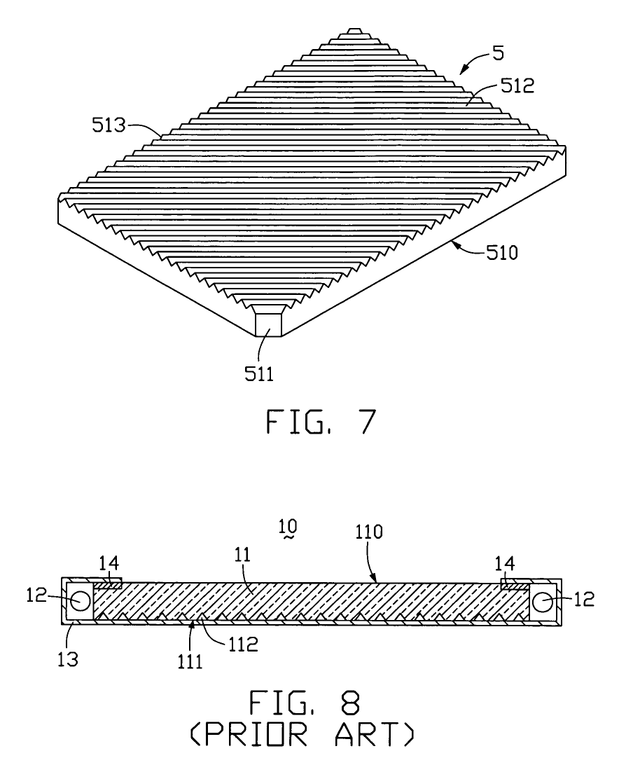

Referring to FIG. 7, a light guide plate 5 according to a fifth embodiment of the present invention has a structure similar to that of the light guide plate 2. The light guide plate 5 includes an oblique portion 511 at a corner between two adjacent sides (not labeled), a light output surface 510, and a bottom surface 512 opposite to the light output surface 510. The oblique portion 511 defines a region for receiving input light beams, and the bottom surface 512 defines a plurality of V-shaped grooves 513 adjoining each other. Each of the V-shaped grooves 513 is bounded by a pair of walls (not labeled) that are essentially parallel to the oblique portion 511. Each of the V-shaped grooves 513 defines an apex angle (not labeled) of about 75°. With such configuration, light beams input to the light input surface 511 can be directed and transmitted within the light guide plate 5 toward particular desired directions. Such directions are typically directions toward a viewer of an associated liquid crystal display panel. Accordingly, a backlight module that employs the light guide plate 5 may advantageously obtain more efficient utilization of illumination and greater brightness in particular desired directions.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate, comprising:
a light output surface; and
a bottom surface opposite to the light output surface, the bottom surface defining a plurality of V-shaped grooves thereat, wherein each of the V-shaped grooves is bounded by a pair of walls along a length thereof, the walls cooperatively define an apex angle, and the apex angle of each of the V-shaped grooves is in a range of 67° to 85°.

2. The light guide plate as claimed in claim 1, wherein each of the apex angles is 75°.

3. The light guide plate as claimed in claim 1, wherein the walls bounding each V-shaped groove maintain substantially a same angle relative to the bottom surface.

4. The light guide plate as claimed in claim 3, wherein the V-shaped grooves are parallel to each other and spaced apart from each other a uniform distance.

5. The light guide plate as claimed in claim 3, wherein the V-shaped grooves are continuously defined at the bottom surface.

6. The light guide plate as claimed in claim 3, wherein a density of the V-shaped grooves increases along a direction away from a light input surface of the light guide plate.

7. The light guide plate as claimed in claim 3, wherein the V-shaped grooves comprise a plurality of semicircular grooves and arc-shaped grooves, all of which are concentric relative to a single reference point.

8. The light guide plate as claimed in claim 3, further comprising an oblique portion at a corner between two adjacent sides thereof.

9. The light guide plate as claimed in claim 8, wherein the oblique portion defines a region for receiving input light beams.

10. The light guide plate as claimed in claim 9, wherein the walls are essentially parallel to the oblique portion.

11. A light guide plate, comprising:
a light output surface; and
a bottom surface opposite to the light output surface, the bottom surface defining a plurality of V-shaped grooves thereat, wherein each of the V-shaped grooves is bounded by a pair of walls along a length thereof, the walls cooperatively form an apex angle, one of the walls maintains an angle in a range of 47°˜58° relative to the bottom surface, and the other wall maintains an angle in a range of 50°˜90° relative to the bottom surface.

12. The light guide plate as claimed in claim 11, wherein the V-shaped grooves are parallel to each other and spaced apart from each other a uniform distance.

13. The light guide plate as claimed in claim 11, wherein the V-shaped grooves are continuously defined at the bottom surface.

14. The light guide plate as claimed in claim 13, wherein a density of the V-shaped grooves increases along a direction away from a light input surface of the light guide plate.

15. The light guide plate as claimed in claim 11, wherein the V-shaped grooves comprise a plurality of semicircular grooves and arc-shaped grooves, all of which are concentric relative to a single reference point.

16. The light guide plate as claimed in claim 11, further comprising an oblique portion at a corner between two adjacent sides thereof.

17. The light guide plate as claimed in claim 16, wherein the walls are essentially parallel to the oblique portion.
